(19) United States
(12) Patent Application Publication
(10) Pub. No.: US 2018/0323678 A1
(43) Pub. Date: Nov. 8, 2018

(54) ADJUSTING DEVICE FOR ADJUSTING A HEADREST POSITION WITH DIRECT DRIVE

(71) Applicant: ELEKTROSIL SYSTEME DER ELEKTRONIK GMBH, Hamburg (DE)

(72) Inventor: Hendrik Niemann, Rosengarten (DE)

(21) Appl. No.: 15/773,360

(22) PCT Filed: Nov. 4, 2016
(86) PCT No.: PCT/EP2016/076682

§ 371 Date: May 3, 2018

(30) Foreign Application Priority Data
Nov. 4, 2015 (DE) 20 2015 105 880.2
Apr. 1, 2016 (DE) 20 2016 101 749.1

(51) Int. Cl. H02K 7/06; B60N 2/829; B60N 2/853; B60N 2/865; F16H 25/20; F16H 25/24; H02K 5/24; H02K 11/215

(52) U.S. Cl. CPC H02K 7/06; B60N 2/829; B60N 2/853; B60N 2/865; F16H 25/20; H02K 2211/03; H02K 5/24; H02K 11/215; F16H 2025/2078; F16H 2025/249; F16H 25/24

(57) ABSTRACT

In order to improve an adjusting device (100, 100a) for electrically adjusting a headrest position in such a way that the entire adjusting device (100, 100a) can be arranged inside of the headrest, so that the adjusting device (100, 100a) can be made more cost effective and reliable in design, it is proposed that an electric motor be movably arranged relative to a spindle (10, 10a), such that a rotary movement of a rotor of the electric motor induces a translational movement (15) of the electric motor along the spindle (10, 10a), or that a rotary movement of a rotor of the electric motor induces a translational movement (15) of the spindle (10, 10a).

### TECHNICAL AREA

The invention relates to an adjusting device for adjusting a headrest position, wherein the adjusting device comprises at least one spindle designed as a threaded spindle and at least one electric motor, said electric motor being in mechanical operative connection with the spindle.

In addition, the invention relates to a headrest for a vehicle seat with an adjusting device for adjusting the headrest position.

The position of headrests of a vehicle seat can usually be manually adjusted. For example, the headrest can be tailored in terms of its height, or the inclination of the headrest can be adjusted.

### PRIOR ART

Electrically adjustable headrests are also known in prior art. To this end, an electric drive is attached inside the backrest of a vehicle seat. The user can utilize corresponding control elements to actuate the electric drive and to change the headrest position, for example to adjust the height of the headrest.

### DESCRIPTION OF THE INVENTION: OBJECT, SOLUTION, ADVANTAGES

The object of the present invention is to improve an adjusting device for electrically adjusting a headrest position in such a way that the entire adjusting device can be arranged inside of the headrest, so that the adjusting device can be made more cost effective and reliable in design.

According to the invention an adjusting device for adjusting, in particular for electrically adjusting, a headrest position is proposed for this purpose. The adjusting device comprises at least one spindle designed as a threaded spindle and at least one electric motor, said electric motor being in mechanical operative connection with the spindle. According to the invention, the electric motor is arranged so that it can move relative to the spindle. To this end, the electric motor is arranged in such a way that a rotary movement of a rotor of the electric motor induces a translational movement of the electric motor along the spindle. Alternatively, the spindle can be movably arranged relative to the electric motor. A rotary movement of a rotor of the electric motor here induces a translational movement of the spindle, i.e., a movement of the spindle relative to the electric motor.

For example, the adjusting device according to the invention can be provided for vertically adjusting the headrest and/or adjusting another position, for example the inclination of the headrest. In particular, the adjusting device is provided for adjusting a headrest position of a headrest for a vehicle, for example a passenger car.

Because the electric motor itself can be moved in a translational movement along the spindle, i.e., linearly along the spindle, the headrest can be moved or adjusted in the same direction in an especially easy manner. To this end, the adjusting device including the drive, specifically the electric motor, is arranged in the headrest itself. By fixedly or rigidly connecting the electric motor with the headrest, the headrest itself is moved together with the electric motor. In contrast, if the spindle is movably arranged relative to the electric motor, the spindle inside of the headrest is fixedly and rigidly connected with the latter.

In comparison to prior art, far less force has to be applied to adjust the headrest position. In adjusting devices known in prior art, the drive is attached inside the backrest of a vehicle seat. In order to adjust the vertical position of a headrest, the drive attached inside the backrest must apply high forces so as to actuate connecting means between the backrest and headrest, and thereby adjust the height of the headrest itself. The adjustment of another position, for example the inclination, is also very cumbersome and difficult to achieve.

The electric motor is preferably arranged so it can move relative to the spindle in such a way as to convert the rotary movement of the rotor into a translational movement of the electric motor itself along the spindle, so that connecting means between the backrest and headrest need not be activated, but the headrest itself being moved or adjusted in conjunction with the movement of the electric motor.

A threaded spindle is to be understood as a threaded rod. The spindle designed as a threaded spindle essentially consists of a cylindrical round rod, upon which is arranged a male thread, for example a trapezoidal, round, buttress, sharp or flat thread. The electric motor comprises a stator and a rotor. The rotary movement of the rotor is converted directly into a translational movement of the entire electric motor, i.e., the rotor and stator, along the spindle. To this end, the electric motor comprises a mechanical operative connection with the spindle.

The adjusting device according to the invention economizes on space by comparison to devices known from prior art, and can thus be arranged in the headrest itself. In addition, the advantage to the device according to the invention is that the drive generates far less noise by comparison to drives known from prior art for adjusting devices used in adjusting headrests, since much less force must be applied to adjust the headrest position, and in particular no mechanical connecting means have to be moved between the backrest and headrest itself. The electric motor can be fixedly connected with the headrest inside of it, so that the movement of the electric motor causes the entire headrest to translationally move along the spindle.

The rotor is preferably arranged around the spindle. As a result, an even more compact arrangement of the adjusting device can be achieved. Furthermore, arranging the rotor around the spindle preferably requires no additional machine elements, for example a gear wheel connected with the rotor of the electric motor via a shaft. The force can be introduced directly from the rotor to the spindle. Therefore, a direct drive is preferably proposed for the headrest position adjusting device.

The electric motor can be operated at a relatively low speed. For example, the electric motor can be operated at a speed of between 100 and 500, particularly preferably of between 200 and 400, for example 300, revolutions per minute. Furthermore, no additional vibration decoupling of the electric motor is necessary. The entire configuration is very precise and robust, since the rotor preferably is arranged around the spindle, and additional machine elements need not be provided next to the spindle for driving purposes. As a consequence, the forces acting on the headrest result in only a minimal, if any, change in the arrangement of the electric motor relative to the spindle inside of the headrest.

Preferably a stator of the electric motor is also arranged around the spindle.

Preferably the male thread of the spindle has a relatively small pitch. The pitch of the male thread of the spindle preferably measures less than 1.0 mm, particularly preferably less than 0.8 mm, and very particularly preferably less than 0.6 mm. For example, the pitch of the male thread of the spindle could measure 0.5 mm. According to the invention, the pitch is to be understood in relation to a metric thread. As a consequence, the pitch is to be understood as the distance between two adjacently arranged threaded tips or flanks of the male thread of the spindle. The pitch thus corresponds to the distance covered by the electric motor in a linear direction along the spindle during a complete rotation of the rotor around the spindle.

The electric motor preferably comprises a housing with fastening means to fasten the electric motor with the headrest. The electric motor is fixedly, for example rigidly, connected with the headrest inside of the latter by means of the housing. For example, such a fastening means can be designed as a flange. The latter can be peripherally arranged protruding from the housing, and have a bore hole for accommodating a screw connection.

In addition, it is preferably provided that the stator of the electric motor is arranged on a circuit board of the electric motor. The circuit board is used to fasten the stator. The stator along with the circuit board can be placed into the housing. As a consequence, it is preferably provided that the housing also completely envelopes the circuit board. For example, the stator can be fastened in the housing via the circuit board. In addition, the circuit board is used to interconnect individual windings of the stator. The circuit board is particularly preferably essentially round in design and/or has an external diameter that is smaller than or equal to the external diameter of the stator itself.

The electric motor preferably comprises at least four, particularly preferably at least six, and very particularly preferably at least eight poles. For example, the electric motor can comprise 10 or 12 poles. By providing a relatively high number of poles, the torque of the electric motor can be increased, and the movement time of the electric motor in a linear or translational direction along the spindle can be accelerated.

The spindle preferably has a length of at least 10 cm, particularly preferably of at least 12 cm, and very particularly preferably of at least 15 cm. As a result, an adjusting path can be provided for the headrest, in particular for a suitable vertical adjustment.

The spindle preferably has synthetic material, particularly preferably a thermoplastic synthetic material, as well as very particularly preferably polyoxymethylene (POM), or consists thereof.

It is also preferably provided that a dampening means for noise insulation is arranged on the inside of the housing of the electric motor to further reduce noise. For example, a dampening means could be flatly arranged, for example adhesively bonded, on the inside of the housing of the electric motor.

The adjusting device preferably further comprises a control unit, wherein the control unit and the electric motor are designed in such a way as to achieve a complete rotation of the rotor by a number of between 6 and 18 impulses. As a result, the electric motor can be moved in a linear or translational direction along the spindle in especially fine or small steps.

In order to acquire the position of the electric motor and/or of the rotor, the electric motor preferably comprises a Hall sensor, as well as particularly preferably at most three Hall sensors. The at least one Hall sensor can be used to acquire the position of the rotor or rotor magnet in the electric motor. As a consequence, the at least one Hall sensor is operatively connected directly with the rotor magnet itself for position acquisition. No additional components, for example additional magnets, are required for position acquisition. Scanning preferably takes place in an axial direction.

In addition, it is preferably provided that the stator of the electric motor as well as the at least one Hall sensor be arranged on the circuit board of the electric motor. A recess is particularly preferably provided in the circuit board for scanning purposes.

The rotor is preferably fixedly connected with a spindle nut, wherein the spindle nut has a female thread that engages with a male thread of the spindle.

Alternatively or additionally, the rotor can have a female thread that engages with a male thread of the spindle. The rotor itself can be arranged around the spindle nut or completely envelop the spindle nut. The force is here transmitted from the rotor to the spindle via the spindle nut.

The mechanical operative connection between the electric motor and spindle is thus achieved by means of a female thread of the rotor that engages with a male thread of the spindle and/or a spindle nut fixedly connected with the rotor. Within the meaning of the present invention, “fixedly connected” means that the spindle nut is connected with the rotor in such a way as to follow the rotational movement of the rotor. The rotor thus imparts a rotational movement to the spindle nut. The spindle nut can here be fixedly connected directly with the rotor, or be connected via another machine element fixedly connected with the rotor, for example a bell.

Within the meaning of this invention, a spindle nut is to be understood as a nut or a tubular machine element, which has a female thread and is screwed onto the spindle or male thread of the spindle.

It is also preferably provided that the electric motor is designed as a brushless motor. The electric motor can be designed as an internal rotor motor, i.e., with a stator arranged around the rotor. Alternatively, the electric motor can be designed as an external rotor motor, i.e., with a rotor arranged around the stator. An air gap is arranged between the rotor and stator around the entire periphery. As a consequence, no physical connections, for example no sliding contacts, are preferably provided between the rotor and stator. This yields an especially low-wear and low-noise driving device. In addition, vibrations can be kept as low as possible.

The electric motor preferably comprises a housing, which is fixedly connected with the stator and/or circuit board. The housing preferably completely envelops the stator and rotor. The housing can likewise completely envelop the spindle nut, wherein the spindle nut need not necessarily be arranged completely inside of the housing. For example, the spindle nut can protrude frontally out of the housing. As a consequence, the spindle nut can have a larger length by comparison to the height or length of the electric motor or housing of the electric motor, and/or adjoin the stator and/or rotor in the longitudinal direction.

The spindle nut preferably also comprises a synthetic material, preferably a thermoplastic synthetic material, as well as very particularly preferably polyoxymethylene (POM), or consists thereof.

Both the spindle and the spindle nut arranged around the spindle are especially preferably made out of synthetic material. An especially strong noise reduction can be achieved as a result.

Also arranged around the rotor is a machine element, in particular in the form of a bell, wherein the machine element is fixedly connected with the rotor. For example, the rotor can be adhesively bonded or pressed into the bell. As a consequence, the bell is connected with the rotor in such a way that the bell turns along with the rotor. The bell preferably is shaped like an open hollow cylinder. The bell completely envelops the rotor and stator.

The bell is preferably fixedly connected with the spindle nut or integrally designed with the spindle nut. As a consequence, the rotational movement is transmitted from the rotor to the spindle nut via the bell.

The bell preferably has a first external diameter. The spindle nut preferably has a second external diameter. The second external diameter is preferably smaller over an entire length of the spindle nut than the first external diameter. What this means is that the external diameter of the spindle nut is smaller than the external diameter of the bell in each area.

It is also preferably provided that the first external diameter is at most 40 mm, particularly preferably at most 35 mm, as well as very particularly preferably at most 30 mm. For example, the first external diameter can be 25 mm. This means that the external diameter of the bell does not exceed the preceding preferred values in any area.

The bell preferably has synthetic material, in particular a thermoplastic synthetic material, or consists of thereof.

The spindle nut further preferably comprises an end section without a female thread. This means that no female thread is arranged in the spindle nut in an end section over a predefined length. The spindle nut envelops the spindle via this end section, without engaging into the male thread on the spindle in the process.

The end section without a female thread preferably has a length corresponding to at least 10%, particularly preferably to at least 20%, of the overall length of the spindle nut.

In addition, at least one bearing is provided, particularly preferably two bearings spaced apart from each other. The at least one bearing is used to mount or guide the electric motor and/or stator on the spindle or male thread of the spindle. The stator here preferably completely envelops at least one bearing. The at least one bearing is preferably fixedly connected with the stator and/or circuit board.

The at least one bearing is particularly preferably designed as a slide bearing, and thus not as a ball bearing.

The adjusting device can comprise an additional spindle designed as a threaded spindle and another electric motor, said other electric motor being in mechanical operative connection with the additional spindle. It is here provided that both spindles be identically designed and identically aligned. Both spindles are particularly preferably aligned parallel to each other. Providing more than one spindle makes it possible to achieve a better stability of the adjusting device for a headrest.

Both the additional spindle and the additional electric motor can have the features described above for a spindle or an electric motor.

Further provided according to the invention is a headrest for a vehicle seat with an adjusting device described above. The adjusting device is arranged inside, preferably completely inside, the headrest. The electric motor of the adjusting device is fixedly, for example rigidly, connected with the headrest via its housing. As a consequence, the headrest follows the movement of the electric motor in a linear or translational direction along the spindle. The entire headrest along with the electric motor can thus be moved relative to the spindle. The spindle itself can be connected with connecting means between the headrest and a backrest of the vehicle seat or mounted thereto, so that the spindle is not moved together with the headrest and electric motor of the adjusting device. As a consequence, the spindle is preferably arranged inside of the headrest, but rigidly connected with a backrest of the vehicle seat. The electric lines for supplying power and actuating the adjusting device can be routed through connecting means between the headrest and backrest of the vehicle seat. In particular, the connecting means can be designed as pipes or be tubular in design for this purpose.

In addition, a headrest is preferably provided, wherein the adjusting device is designed to vertically adjust the headrest and/or to adjust an inclination of the headrest and/or to move an element arranged in the headrest. For example, an element arranged in the headrest can be provided in the form of a cushion or a plate in the front area of the headrest. The perceived position or inclined position of the headrest can be varied for the user by the movement, for example by pushing forward or pulling back this element arranged in the headrest. As a result, it is not necessary to change the actual inclination of the entire headrest, but rather only to push the front contact surface of the headrest further toward the front or move it back.

A headrest with at least two adjusting device is also preferably provided, wherein the first adjusting device for vertically adjusting the headrest is arranged inside of the latter, and wherein the second adjusting device for adjusting the inclination of the headrest and/or moving an element arranged inside of the headrest is arranged inside of the headrest. As a result, a headrest can be provided that can be adjusted both in relation to its height and in relation to its inclination or perceived inclination. Both adjusting devices are preferably arranged completely inside of the headrest.

In addition, a heating module for forming a neck-level heating system is preferably arranged inside of the headrest.

### BRIEF DESCRIPTION OF THE DRAWINGS

The invention will now be exemplarily explained in reference to the accompanying drawings based upon particularly preferred embodiments.

Schematically depicted are:

FIG. 1: a perspective view of an adjusting device for adjusting a headrest position;

FIG. 2: a perspective view of an adjusting device without a housing;

FIG. 3: a sectional view through a section of an adjusting device for adjusting a headrest position;

FIG. 4: a perspective view of an adjusting device without a housing;

FIG. 5: a perspective view of an adjusting device without a housing;

FIG. 6: a sectional view through a section of an adjusting device for adjusting a headrest position;

FIG. 7: a headrest of a vehicle seat with an adjusting device for vertically adjusting the headrest, and

FIG. 8: a headrest with adjusting device for actuating an element arranged in the headrest.

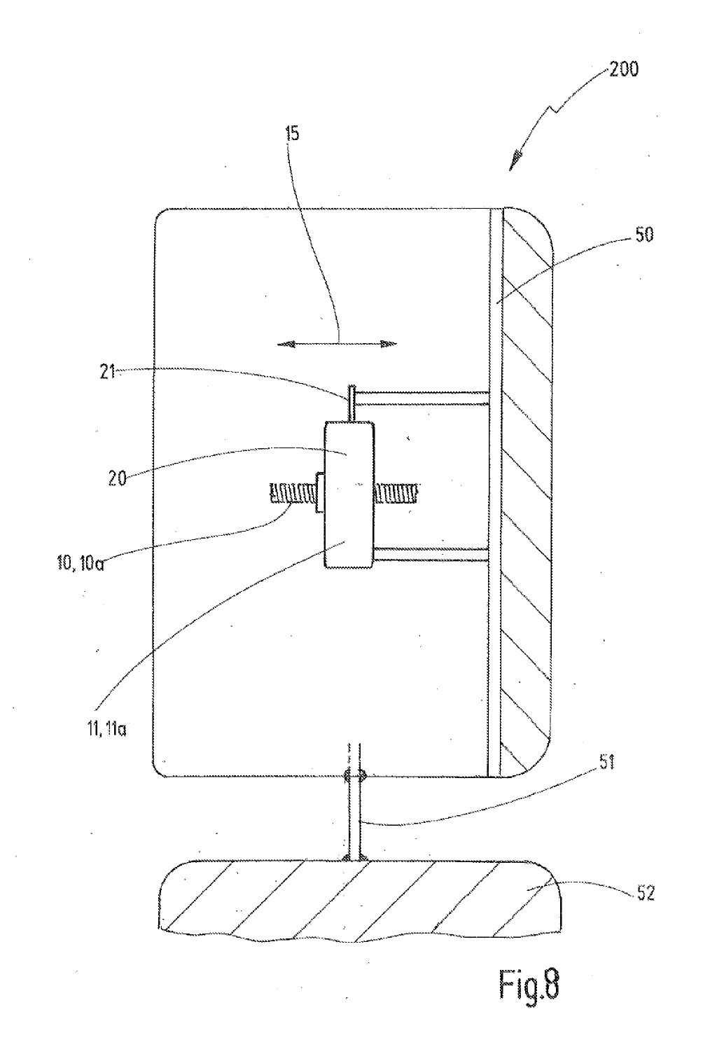

### PREFERRED EMBODIMENTS OF THE INVENTION

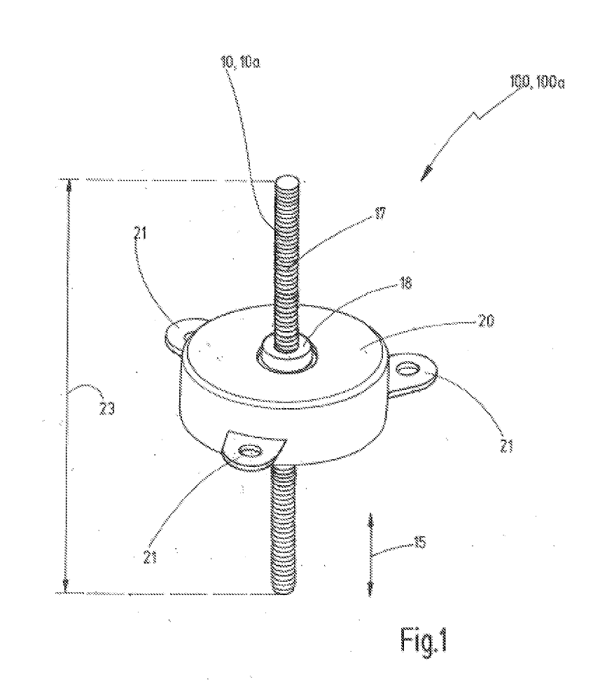

FIG. 1 shows a perspective view of an adjusting device 100, 110a for adjusting a headrest position. The adjusting device 100, 100a has a spindle 10, 10a designed as a threaded spindle, and an electric motor 11, 11a wherein the electric motor 11, 11a comprises a mechanical operative connection with the spindle 10, 10a. The electric motor 11, 11a is arranged in a housing 20. The electric motor 11, 11a is movably arranged relative to the spindle 10, 10a, so that a rotary movement 14 of the rotor 12 (not shown on FIG. 1) of the electric motor 11, 11a induces a translational movement 15 of the electric motor 11, 11a along the spindle 10, 10a.

The fastening means 21 arranged completely around the housing 20 of the electric motor 11, 11a can be used fixedly connect the electric motor 11, 11a via its housing 20 to the headrest 200 inside of the latter (not shown on FIG. 1). The headrest 200 thus follows the movement of the electric motor 11, 11a, or is moved together with the electric motor 11, 11a in a linear or translational direction along the spindle 10, 10a.

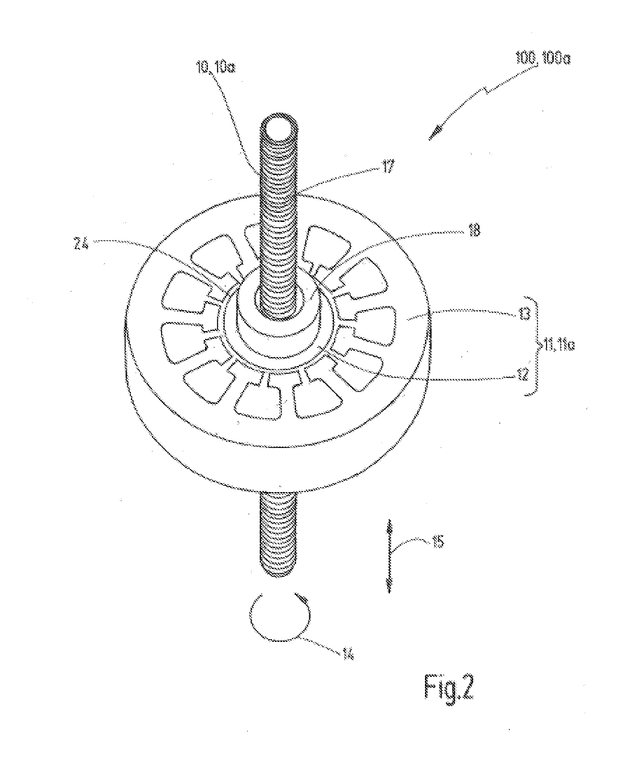

FIG. 2 shows a perspective view of the adjusting device 100, 100a, wherein the housing 20 of the electric motor 11, 11a was removed to provide a better overview. The electric motor 11, 11a has a stator 13 with a plurality of poles. The stator 13 completely envelops a rotor 12, which is designed as a permanent magnet or at least has a permanent magnet. The electric motor 11, 11a is designed as a brushless electric motor 11, 11a. This means that no mechanical contacts, for example sliding contacts, are provided between the stator 13 and rotor 12 of the electric motor 11, 11a. As a consequence, an air gap 24 is provided between the stator 13 and rotor 12 around the entire periphery.

Both the rotor 12 and stator 13 are arranged around the spindle 10, 10a. The rotor 12 completely envelops a spindle nut 18. The spindle nut 18 at least zonally has a female thread 16 (not shown on FIG. 2), which engages with the male thread 17 of the spindle 10, 10a. The spindle nut 18 is fixedly connected with the rotor 12, so that the rotary movement 14 or rotational movement of the rotor 12 is imparted to the spindle nut 18. As a consequence, this rotary movement 14 of the rotor is imparted to the spindle 10, 10a via the spindle nut 18, and converted into a translational movement 15 of the entire electric motor 11, 11a along the spindle 10, 10a.

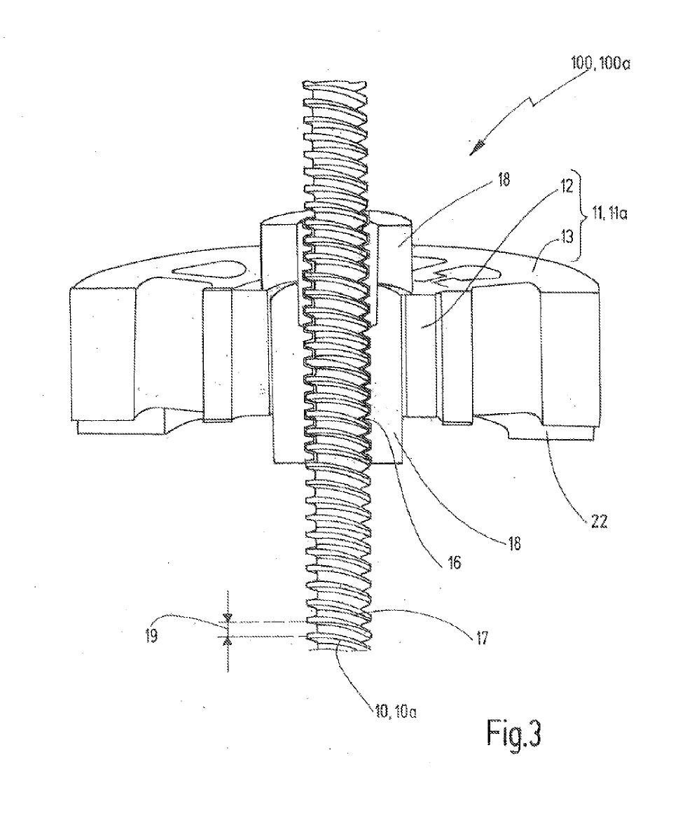

FIG. 3 shows a section of the adjusting device 100, 100a in a sectional view. As clearly shown, the spindle nut 18 zonally has a female thread 16, which engages with the male thread 17 of the spindle 10, 10a.

The pitch 19 selected for the male thread 17 is especially small, so that the transmission ratio is small, and the electric motor 11, 11a, and hence also the entire headrest 200 (not shown on FIG. 3), can be adjusted in small steps. For example, the pitch 19 of the male thread 17 measures 0.5 mm.

In the adjusting device 100, 100a depicted on FIGS. 1-3, the electric motor 11, 11a is designed as an internal rotor motor. The stator 13 is thus arranged around the rotor 12. The rotor 12 either rests with its female thread 16 on the spindle 10, 10a, or is arranged on the spindle 10, 10a via a spindle nut 18 with a female thread 16.

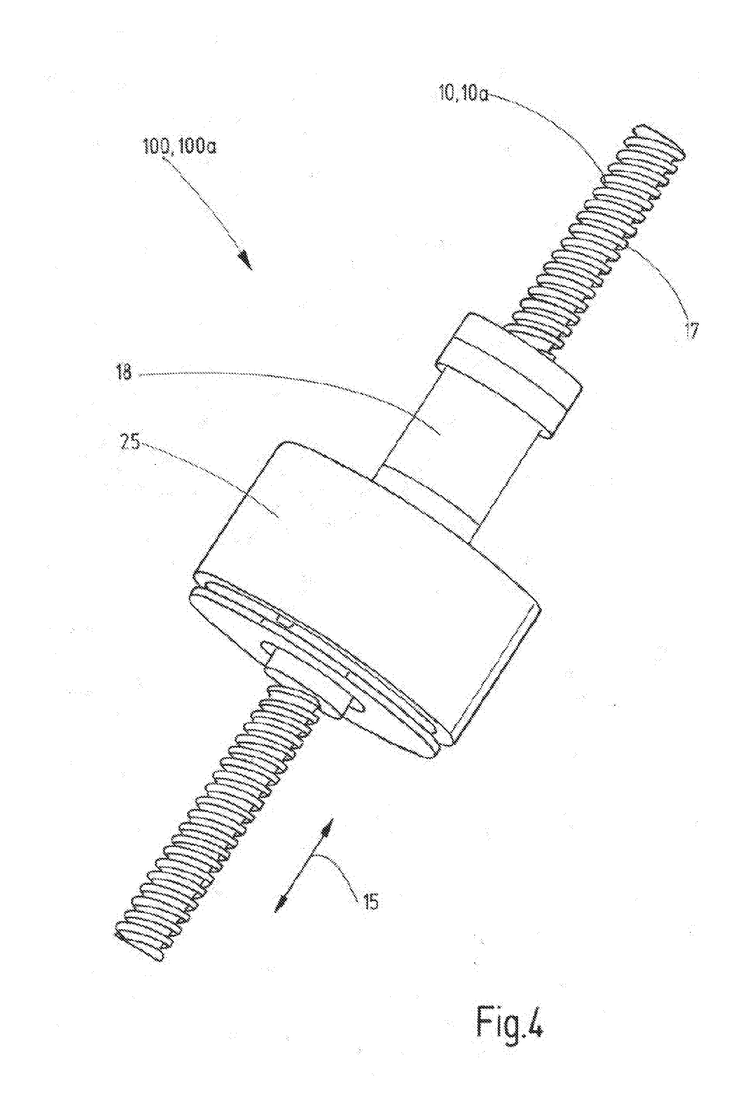

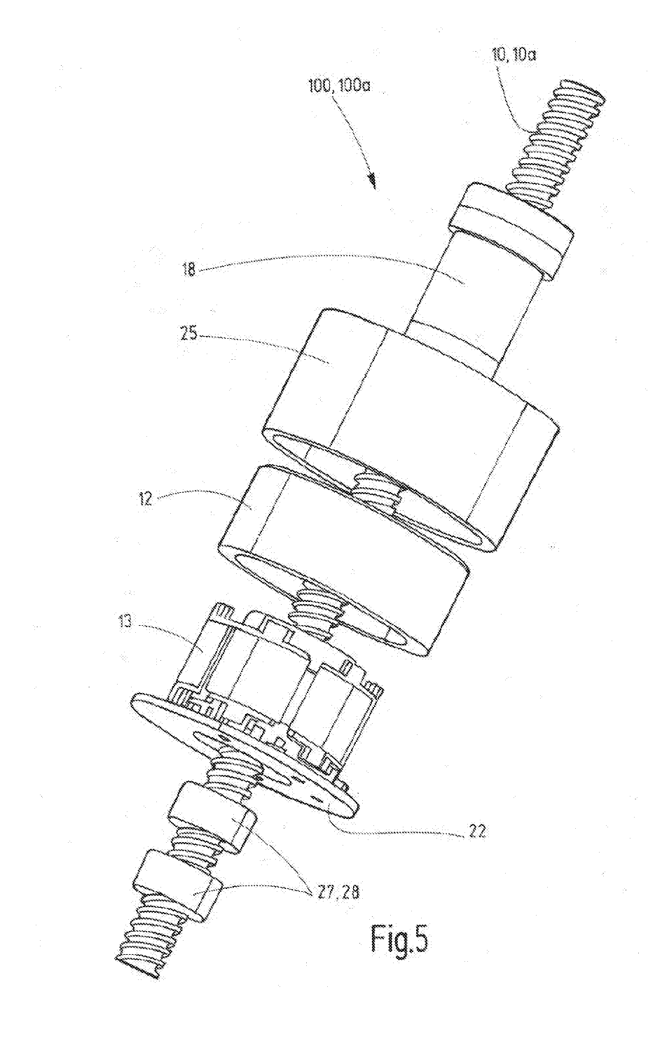

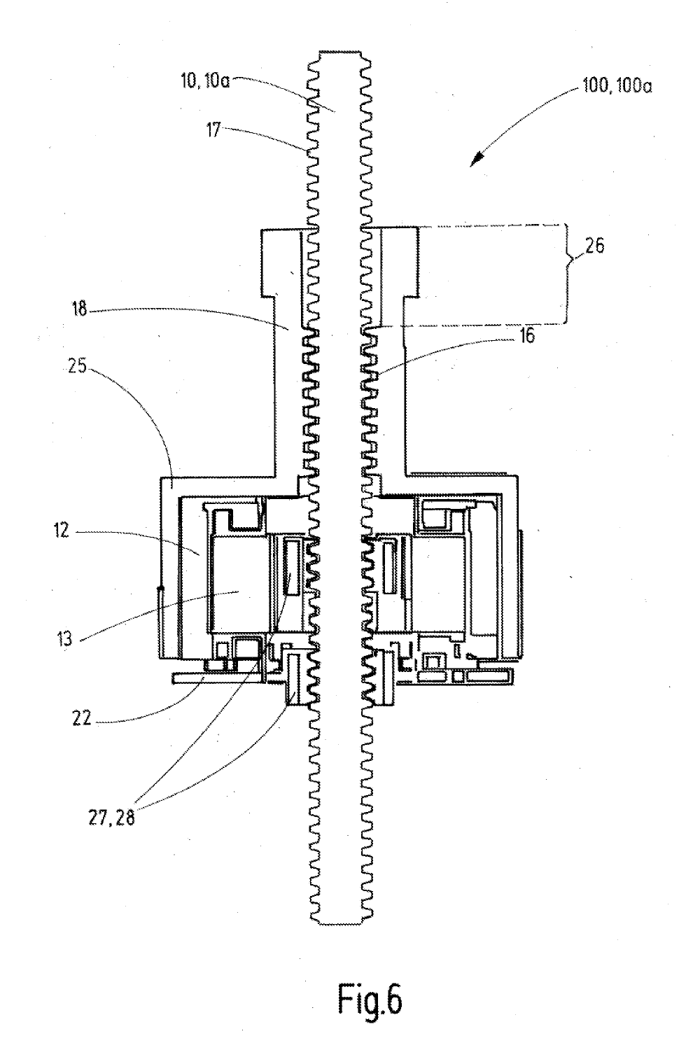

FIGS. 4 and 5 show additional perspective views of an adjusting device 100, 100a for vertically adjusting a headrest 200 (not depicted on the figures). FIG. 6 shows a sectional view through an adjusting device 100, 100a. FIGS. 4-6 show an adjusting device 100, 100a, wherein the electric motor 11, 11a is designed as an external rotor motor. The rotor 12 is here arranged around the stator 13.

The stator 13 or entire electric motor 11, 11a is mounted on the spindle 10, 10a via two bearings 27, 28 spaced apart from each other. The two bearings 27, 28 are here designed as slide bearings.

The rotor 12 is pressed or adhesively bonded into a bell 25, and thus rigidly connected with the latter. The bell 25 is integrally designed with the spindle nut 18. As a consequence, the rotational movement of the rotor 12 is transmitted to the spindle nut 18 by way of the bell 25. The bell 25 together with the spindle nut 18 is turned along with the rotor 12.

The spindle nut 18 has a female thread 16, which engages with the male thread 17 of the spindle 10, 10a. An end section 26 of the spindle nut 18 is here designed without a female thread.

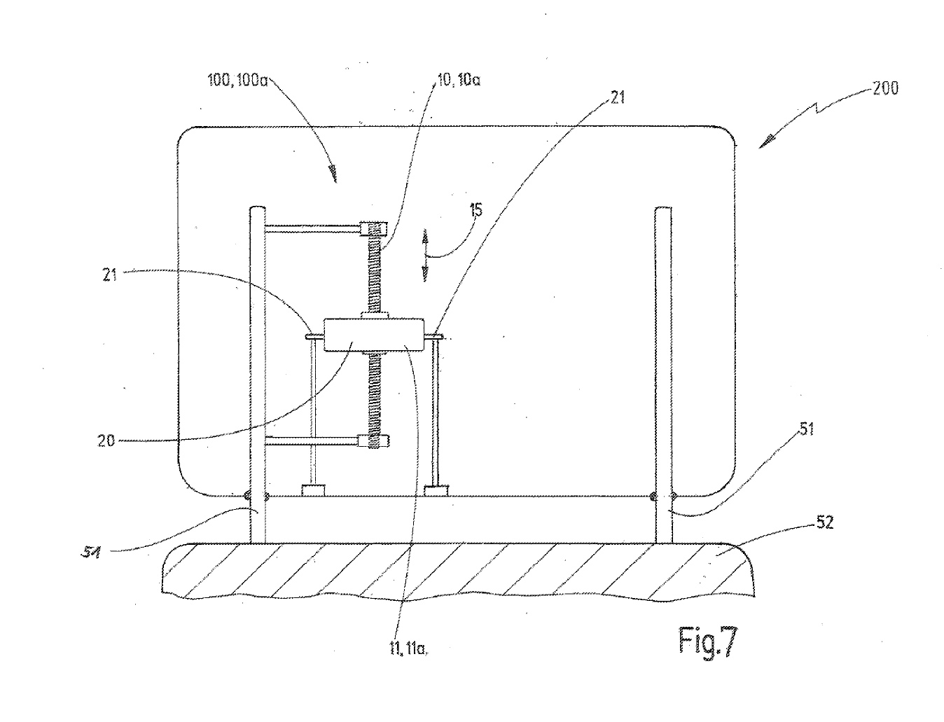

FIG. 7 shows a headrest 200 with an adjusting device 100, 100a arranged therein for vertically adjusting the headrest 200. The headrest 200 is connected with the backrest 52 of the vehicle seat via two connecting means 51.

The linear or translational movement 15 along the spindle 10, 10a of the electric motor 11, 11a or the entire headrest 200 changes the vertical position of the headrest 200. To this end, the electric motor 11, 11a is fixedly connected via its housing inside of the headrest 200 with the latter. The headrest 200 thus follows the translational direction of movement 15 of the entire electric motor 11, 11a. The spindle 10, 10a is connected with a connecting means 51 between the headrest 200 and the backrest 52 of the vehicle seat, so that the spindle 10, 10a follows no movement when adjusting the headrest 200.

The headrest 200 can have two adjusting devices 100, 100a of the kind depicted on FIG. 4. For example, an adjusting device 100, 100a could be arranged in the area of each of the two connecting means 51 between the headrest 200 and the backrest 52 of the vehicle seat.

FIG. 6 shows a headrest 200 with the adjusting device 100, 100a arranged therein. As opposed to the embodiment depicted on FIG. 4, the embodiment shown on FIG. 5 serves to activate or move an element 50 inside of the headrest 200. As a result, the position of the headrest 200 is altered in a vertical direction by outwardly pressing the essentially flatly designed element 50 arranged inside of the headrest 200, thereby expanding the headrest 200 or retracting the element 50. As a consequence, the user at least intuitively feels as though the inclination of the headrest 200 changes.

Several adjusting devices 100, 100a can also be provided in a headrest 200. For example, an adjusting device 100 for vertical adjustment can be provided in a headrest 200, as can an additional adjusting device 100a for actuating the element 50 arranged inside of the headrest 200.

### REFERENCE LIST

100, 100a Adjusting device
200 Headrest
10, 10a Spindle
11, 11a Electric motor
12 Rotor
13 Stator
14 Rotary movement
15 Translational movement
16 Female thread
17 Male thread
18 Spindle nut
19 Pitch of male thread
20 Housing
21 Fastening means
22 Circuit board
23 Length of spindle
24 Air gap
25 Bell
26 End section
27, 28 Bearing
50 Element
51 Connecting means between headrest and a backrest of vehicle seat
52 Backrest of vehicle seat

1. An adjusting device for adjusting a headrest position, wherein the adjusting device comprises at least one spindle designed as a threaded spindle and at least one electric motor, said electric motor being in mechanical operative connection with the spindle,
wherein the electric motor is movably arranged relative to the spindle, such that a rotary movement of a rotor of the electric motor induces a translational movement of the electric motor along the spindle, or that the spindle is movably arranged relative to the electric motor, such that a rotary movement of a rotor of the electric motor induces a translational movement of the spindle,
wherein the rotor is arranged around the spindle.

2. (canceled)

3. The adjusting device according to claim 1,
wherein a pitch of a male thread of the spindle is less than 1.0 mm.

4. The adjusting device according to claim 1,
wherein a housing of the electric motor comprises fastening means for fastening the electric motor with the headrest.

5. The adjusting device according to claim 1,
wherein a stator of the electric motor is arranged on a circuit board of the electric motor.

6. The adjusting device according to claim 1,
wherein the electric motor comprises at least four poles.

7. The adjusting device according to claim 1,
wherein the spindle has a length of at least 10 cm.

8. The adjusting device according to claim 1,
wherein the spindle comprises plastic, and/or wherein the spindle is designed self-lubricating.

9. The adjusting device according to claim 1,
wherein the electric motor comprises a housing, wherein a dampening means for noise dampening is arranged on the inside of the housing.

10. The adjusting device according to claim 1,
wherein the adjusting device comprises a control unit, wherein the control unit and the electric motor are designed in such a way as to achieve a complete rotation of the rotors by a number of between 6 and 18 impulses.

11. The adjusting device according to claim 1,
wherein the electric motor for acquiring the position of the rotor comprises at least one Hall sensor, which is designed to acquire the position of a rotor magnet of the rotor and which is arranged in the electric motor.

12. The adjusting device according to claim 11,
wherein a stator of the electric motor and the at least one Hall sensor are arranged on a circuit board of the electric motor.

13. The adjusting device according to claim 1,
wherein the adjusting device comprises an additional spindle designed as a threaded spindle and another electric motor, said other electric motor being in mechanical operative connection with the additional spindle.

14. The adjusting device according to claim 1,
wherein the rotor is fixedly connected with a spindle nut, wherein the spindle nut comprises a female thread that engages with the male thread of the spindle.

15. The adjusting device according to claim 1,
wherein the electric motor is designed as a brushless motor and comprises a stator, wherein the electric motor is designed as an internal rotor motor or as an external rotor motor, wherein an air gap is arranged between the rotor and the stator around the entire periphery.

16. The adjusting device according to claim 15,
wherein the electric motor comprises a housing, which is fixedly connected with the stator and/or the circuit board.

17. The adjusting device according to claim 14,
wherein the spindle nut comprises plastic, and/or wherein the spindle nut is designed self-lubricating.

18. The adjusting device according to claim 1,
wherein the rotor comprises a female thread that engages with the male thread of the spindle.

19. The adjusting device according to claim 14,
wherein the rotor completely envelops the spindle nut.

20. The adjusting device according to claim 1,
wherein a bell is arranged around the rotor, wherein the bell is fixedly connected with the rotor.

21. The adjusting device according to claim 14,
wherein the bell is fixedly connected with the spindle nut or integrally designed with the spindle nut.

22. The adjusting device according to claim 21,
wherein the bell has a first external diameter, wherein the spindle nut has a second external diameter, wherein the second external diameter is smaller than the first external diameter over an entire length of the spindle nut.

23. The adjusting device according to claim 22,
wherein the first external diameter is at most 40 mm.

24. The adjusting device according to claim 20,
wherein the bell comprises plastic.

25. The adjusting device according to claim 14,
wherein the spindle nut comprises an end section without a female thread.

26. The adjusting device according to claim 25,
wherein the end section has a length corresponding to at least 10% of an overall length of the spindle nut.

27. The adjusting device according to claim 1,
wherein the electric motor is mounted on the spindle by means of at least one bearing.

28. Headrest for a vehicle seat with an adjusting device according to claim 1,
wherein the adjusting device is arranged inside of the headrest.

29. The headrest according to claim 28,
wherein the adjusting device is designed to vertically adjust the headrest and/or to adjust an inclination of the headrest and/or to adjust a depth of the headrest and/or to move an element arranged in the headrest.

30. The headrest according to claim 28,
wherein the headrest comprises two adjusting devices according to claim 1, wherein the first adjusting device for vertically adjusting the headrest is arranged inside of the headrest, wherein the second adjusting device for adjusting an inclination of the headrest and/or for adjusting a depth of the headrest and/or for moving an element arranged inside of the headrest is arranged inside of the headrest.

31. The headrest according to claim 28,
wherein a heating module for forming a neck-level heating system is arranged inside of the headrest.
